(19) United States
(12) Patent Application Publication
(10) Pub. No.: US 2026/0285133 A1
(43) Pub. Date: Sep. 24, 2026

(54) TAILGATE SYSTEM

(71) Applicants: Hyundai Motor Company, Seoul (KR); Kia Corporation, Seoul (KR)

(72) Inventor: Duck Young KIM, Hwaseong-si (KR)

(73) Assignees: Hyundai Motor Company, Seoul (KR); Kia Corporation, Seoul (KR)

(21) Appl. No.: 19/305,414

(22) Filed: Aug. 20, 2025

(30) Foreign Application Priority Data
Mar. 19, 2025 (KR) 10-2025-0035369

(51) Int. Cl. B60J 5/10; B60J 5/12

(52) U.S. Cl. CPC B60J 5/106; B60J 5/12

(57) ABSTRACT

A tailgate system includes: a tailgate disposed at a rear of a vehicle to open or close an internal space of the vehicle; a rotation unit disposed in the vehicle and connected, at an end portion thereof, to the tailgate to rotate the tailgate by operation; and a sliding unit disposed in the tailgate and connected, at an end portion thereof, to the rotation unit, the sliding unit being configured to implement a linear movement of the tailgate by selective operation during rotation of the tailgate.

### CROSS-REFERENCE TO RELATED APPLICATION(S)

The present application is based on and claims priority under 35 U.S.C. 119 to Korean Patent Application No. 10-2025-0035369, filed on March 19, 2025, in the Korean Intellectual Property Office, the disclosure of which is herein incorporated by reference in its entirety.

### BACKGROUND OF THE INVENTION

### Field of the Present Disclosure

The present disclosure relates to a tailgate system.

### Description of the Related Art

A tailgate is a door or cover located at the rear of a vehicle, primarily designed to facilitate the loading and unloading of cargo. The tailgate typically operates by opening downward or lifting upwards.

The foregoing described as the background art is intended merely to aid in the understanding of the background of the present disclosure, and is not intended to mean that the present disclosure falls within the purview of the related art already known to those skilled in the art.

### SUMMARY OF THE INVENTION

In recent years, power tailgates that, when a button is pressed, automatically open or close by use of a driving motor for the opening and closing of the tailgate have been applied to vehicles. However, in the case of a tailgate that opens by rotating upward toward the vehicle roof, it may be difficult to open the tailgate if there is insufficient space around the vehicle or if there is an obstacle.

The present disclosure has been provided to solve such a problem, and aims to provide a tailgate system that enables a tailgate to open or close without collision even in a confined space.

The technical subjects pursued in the present disclosure may not be limited to the above-mentioned technical subjects, and other technical subjects which are not mentioned herein may be clearly understood from the following descriptions by those skilled in the art to which the present disclosure pertains.

In view of the foregoing, a tailgate system includes: a tailgate disposed at a rear of a vehicle to open or close an internal space of the vehicle; a rotation unit disposed in the vehicle and connected, at an end, to the tailgate to rotate the tailgate by operation; and a sliding unit disposed in the tailgate and connected, at an end, to the rotation unit, the sliding unit being configured to implement a linear movement of the tailgate by selective operation during rotation of the tailgate.

According to an exemplary embodiment of the present disclosure, the rotation unit may include: a first motor disposed on a roof of the vehicle; and a gooseneck bar including a first end portion coupled to a shaft of the first motor and the other end portion coupled to the sliding unit. The sliding unit may include: a second motor disposed in the tailgate; and a sliding rail disposed in the tailgate to extend in a height direction of the tailgate, the gooseneck bar being slidably coupled to an end portion of the sliding rail.

According to an exemplary embodiment of the present disclosure, the first motor may be configured to rotate the tailgate by rotating the gooseneck bar about the shaft of the first motor, and when the second motor is selectively operated, a linear movement of the tailgate is implemented to implement a climbing movement of the tailgate.

According to an exemplary embodiment of the present disclosure, the gooseneck bar includes, at the second end portion thereof, a roller body coupled to the sliding rail, and the sliding unit may further include a movement unit connected to the second motor to slide the roller body.

According to an exemplary embodiment of the present disclosure, a roller may be disposed between the roller body and the sliding rail to assist sliding of the roller body.

According to an exemplary embodiment of the present disclosure, the movement unit may include: a first pulley disposed at a first end portion of the sliding rail and connected to the second motor; a second pulley disposed at the other end portion of the sliding rail; and a cable coupled to the first pulley and the second pulley, both end portions of the cable being coupled to the roller body.

According to an exemplary embodiment of the present disclosure, the sliding rail may include, at the first end portion thereof, a bracket to which the first pulley is rotatably coupled.

According to an exemplary embodiment of the present disclosure, a pulley pin may be coupled to the other end portion of the sliding rail, and the second pulley may be coupled to the pulley pin.

According to an exemplary embodiment of the present disclosure, a bevel gear may be disposed on a shaft of the second motor, and operation of the bevel gear may cause the first pulley and the second pulley to rotate to slide the roller body.

According to an exemplary embodiment of the present disclosure, a protruding striker may be disposed on one surface of the roller body, and a stopper configured to receive the striker is disposed at a first end portion or the other end portion of the sliding rail, to restrict sliding of the roller body.

According to an exemplary embodiment of the present disclosure, the cable may be fixed to the roller body by a bolt.

According to an exemplary embodiment of the present disclosure, the cable may include, at a first end portion thereof, a head configured to be inserted into the roller body, and at the other end portion thereof, a head clip configured to be fastened to the head inserted into the roller body.

According to an exemplary embodiment of the present disclosure, the roller body may include, at a predetermined portion thereon, a head insertion hole into which the head is inserted, and around the head insertion hole, a clip seating groove into which the head clip is seated.

According to the tailgate system of the present disclosure, when a parking space is confined, a climbing movement of the tailgate may be implemented to open or close the tailgate without colliding with surrounding obstacles, and when the parking space is sufficient, a rotation of the tailgate may be implemented to open or close the tailgate.

Advantageous effects obtainable from the present disclosure may not be limited to the above-mentioned effects, and other effects which are not mentioned herein may be clearly understood from the following descriptions by those skilled in the art to which the present disclosure pertains.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a view exemplarily illustrating a protrusion of a tailgate resulting from a general opening;

FIG. 2 is a view exemplarily illustrating a tailgate system according to an exemplary embodiment of the present disclosure in a state in which the tailgate is opened;

FIGS. 3, 4 and 5, are views sequentially illustrating the opening of the tailgate of the tailgate system according to an exemplary embodiment of the present disclosure;

FIG. 6 is a view exemplarily illustrating the tailgate system excluding a vehicle panel;

FIG. 7 is a view exemplarily illustrating a connection between the gooseneck bar and a roller body;

FIG. 8 is a view exemplarily illustrating a cross-sectional view taken along line A-A of FIG. 7;

FIG. 9 is a rear view of FIG. 6;

FIG. 10 is an enlarged view exemplarily illustrating a gooseneck bar, a roller body, and a sliding rail;

FIG. 11 is an enlarged view exemplarily illustrating a sliding unit;

FIG. 12 is an enlarged view exemplarily illustrating a second pulley; and

FIG. 13 is a view exemplarily illustrating another embodiment of coupling between the cable and the roller body.

### DETAILED DESCRIPTION OF THE EXEMPLARY EMBODIMENTS

In describing the embodiments set forth herein, a detailed description of known functions or configurations incorporated herein will be omitted when it is determined that the description may make the subject matter of the embodiments set forth herein unclear. In addition, it should be appreciated that the accompanying drawings are disposed only for the sake of easy understanding of the embodiments set forth herein, and the technical idea of the present disclosure is not limited to the accompanying drawings and includes all modifications, equivalents, or alternatives falling within the spirit and scope of the present disclosure. The following descriptions are not intended to limit the present disclosure to the described form or specific field, and it is considered that various alternative modifications and changes may be made to the present disclosure regardless of whether the descriptions are explicit or implicit. Those skilled in the art to which the present disclosure pertains will appreciate that the contents of the present disclosure may be changed in forms and details.

The present disclosure will be described with reference to specific embodiments. However, as understood by a person ordinarily skilled in the art to which the present disclosure belongs, the various aspects included herein may be modified or otherwise implemented in different ways without departing from the spirit and scope of the present disclosure. Accordingly, the following description is to be considered exemplary, and is intended to teach those ordinarily skilled in the art to which the disclosure belongs how to make and use various embodiments. It is to be understood that the forms of the disclosure illustrated and described herein are exemplary embodiments. Equivalent elements, materials, processes, or steps may be substituted for those exemplified and described in the present disclosure. Expressions used in the present disclosure, such as “including,” “comprising,” “incorporating,” “consisting of,” “having,” or “is,” should be interpreted in a non-exclusive manner, i.e., to allow for the inclusion of items, components, or elements not explicitly listed. In addition, references to the singular form should be interpreted to include the plural form as well.

Furthermore, the various embodiments disclosed herein should be regarded as exemplary and descriptive, and should not be construed as limiting the scope of the present disclosure. All references to joining (e.g., attached, affixed, coupled, and connected) are used solely to facilitate understanding of the present disclosure and are not intended to limit the position, orientation, or use of any component or method disclosed herein. Accordingly, references to joining should be interpreted broadly. Moreover, these references to joining do not imply that two or more elements are directly connected to each other. Furthermore, all numerical terms, such as “first,” “second,” “third,” “primary,” “secondary,” “main,” or any other generic terms or numerical expressions, are to be understood solely as identifiers to aid in the understanding of the various components, embodiments, modifications, or variations of the present disclosure, and do not imply any limitations as to any component, embodiment, modification, variation, or their order or preference. That is, these terms may be used to describe various components but should not be construed as limiting the components to those terms. These terms are used only to distinguish one component from another.

The terms "module" and "unit" used for the elements in the following description are given or interchangeably used in consideration of only the ease of writing the specification, and do not have distinct meanings or roles by themselves.

In the case where an element is referred to as being "connected" or "coupled" to any other elements, it should be understood that not only the element may be directly connected or coupled to the other elements, but also another element may exist therebetween. Contrarily, in the case where an element is referred to as being "directly connected" or "directly coupled" to any other element, it should be understood that no other element exists therebetween.

Furthermore, a unit or a control unit included in names is merely a term widely used for naming a controller configured to control a specific function of a vehicle, but does not mean a generic function unit.

To control functions in charge, a controller may include a communication device configured to communicate with a sensor or another controller, a memory configured to store an operating system or logic instructions and input/output information, and at least one processor configured to perform determination, calculation, decision, or the like required for control of the functions in charge.

Any number or variety of components in any of the configurations described herein may be included within the scope of the present disclosure described herein. The components may include any combination of the features described herein and may be arranged in any of the various configurations described herein. The concepts related to the structure and arrangement of the components of the present disclosure, as well as their use and operation, may be applied to any number of embodiments in any combination, as well as to the specific embodiments discussed herein. Embodiments including those having various features in various arrangements are described below with reference to the drawings.

Hereinafter, various embodiments set forth herein will be described in detail with reference to the accompanying drawings, and the same or similar elements are given the same and similar reference numerals regardless of figure numbers, so duplicate descriptions thereof will be omitted.

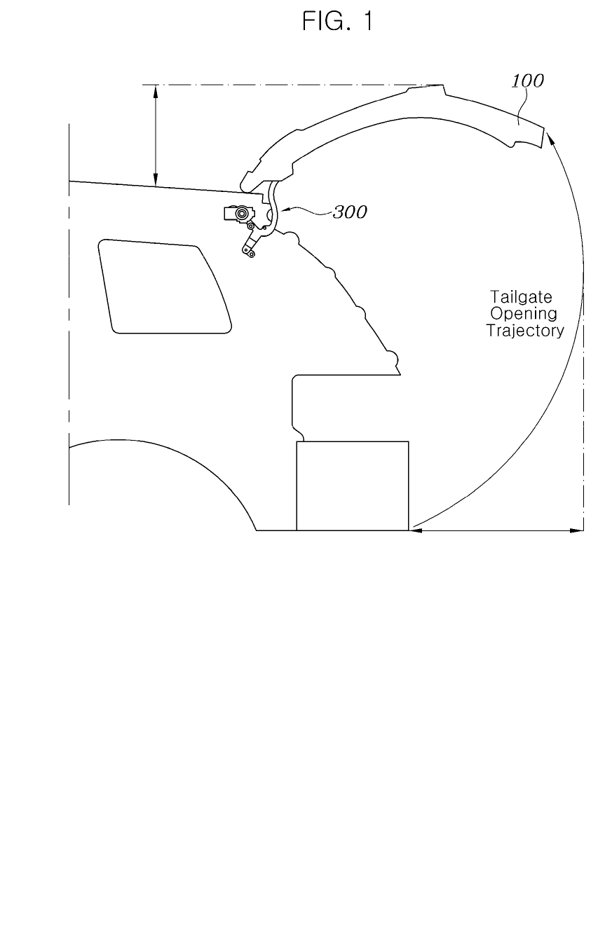

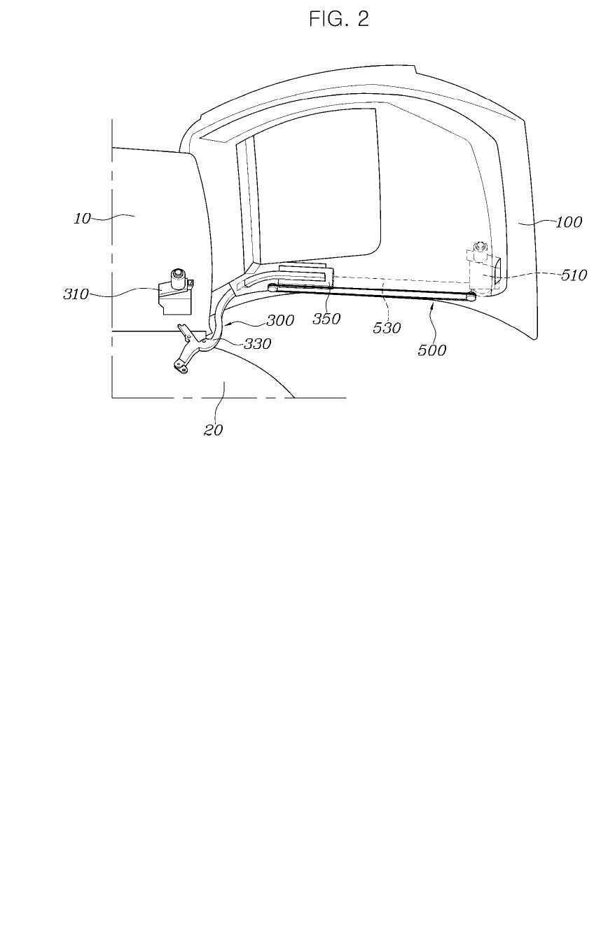

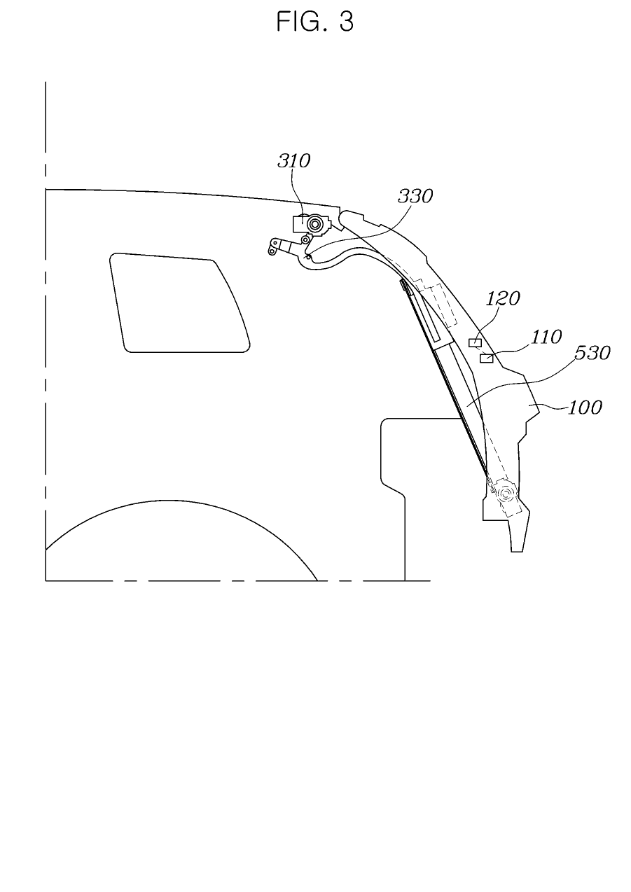

FIG. 1 illustrates a protruding state of a tailgate resulting from a general opening. FIG. 2 illustrates a tailgate system according to an exemplary embodiment of the present disclosure in a state in which the tailgate is opened. FIGS. 3 to 5 sequentially illustrate the opening of the tailgate of the tailgate system according to an exemplary embodiment of the present disclosure.

Referring to FIGS. 1 to 5, a tailgate is generally opened or closed by rotating upward or downward about a roof as a rotation center. As illustrated in FIG. 1, when the tailgate 100 is opened, the tailgate 100 may protrude significantly, and thus may collide with surrounding obstacles (e.g., an external wall of a building) in a confined parking space, and it is difficult for a user to predict a trajectory caused by the rotation of the tailgate 100. Thus, when the user forcibly opens the tailgate 100 in a confined space, the tailgate 100 may be damaged by surrounding obstacles, or a situation may occur where the tailgate 100 is opened precariously.

The present disclosure is intended to allow the tailgate 100 to be opened in a general manner when a sufficient parking space is available, and to allow the tailgate 100 to be opened without damage by minimizing the protrusion caused by the movement of the tailgate 100 through implementation of a climbing movement of the tailgate 100 when the parking space is confined.

A tailgate system according to an exemplary embodiment of the present disclosure includes: a tailgate 100, which is disposed at a rear of a vehicle to open or close an internal space of the vehicle; a rotation unit 300, which is disposed in the vehicle and connected at a first end portion to the tailgate 100, the rotation unit being configured to rotate the tailgate 100 by operation; and a sliding unit 500, which is disposed in the tailgate 100 and connected at a first end portion thereof to the rotation unit 300, the sliding unit being configured to implement a linear movement of the tailgate 100 by selective operation during rotation of the tailgate 100.

The movement of the tailgate 100 may be implemented by the rotation unit 300 and the sliding unit 500. During the opening of the tailgate 100, the rotation unit 300 is always operated, whereas the sliding unit 500 may be selectively operated. In other words, when a sufficient parking space is available, only the rotation unit 300 is operated during the opening and closing of the tailgate 100 to open or close the tailgate 100 by rotation, and when the parking space is confined, both the rotation unit 300 and the sliding unit 500 are operated during the opening/closing of the tailgate 100.

Referring to FIG. 2, the rotation unit 300 may be disposed on a roof 10 of the vehicle to rotate the tailgate 100 about the roof 10 of the vehicle. The sliding unit 500 may be disposed in the tailgate 100 and connected at a first end portion thereof to the rotation unit 300 to implement a climbing movement of the tailgate 100 when the rotation unit 300 and the sliding unit 500 operate together.

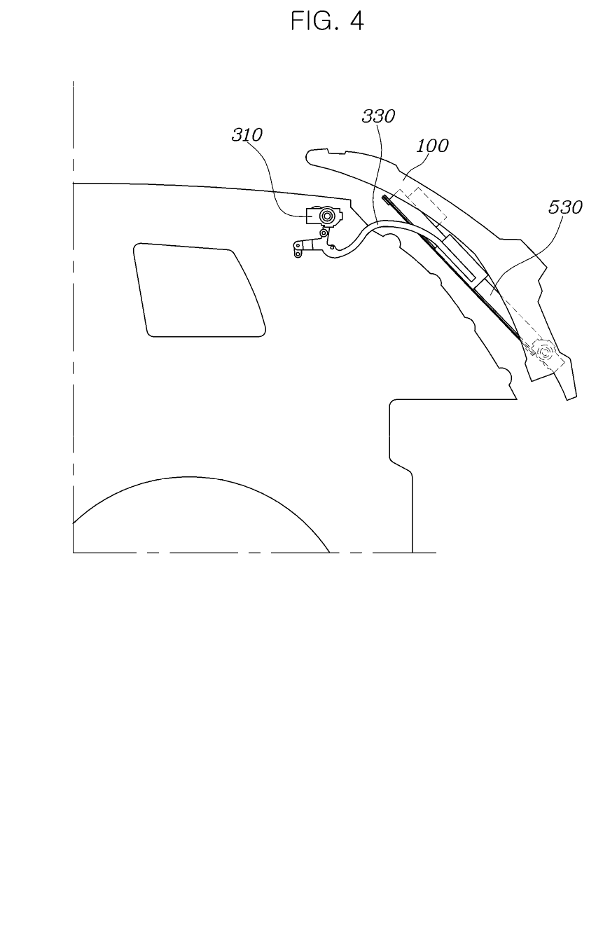

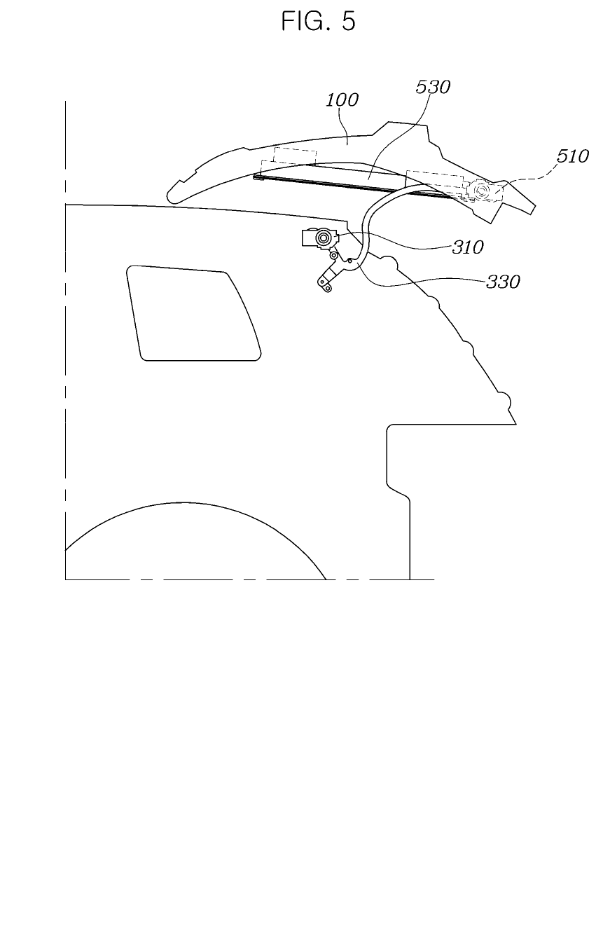

Referring to FIGS. 3 to 5, when the parking space is confined, the climbing movement of the tailgate 100 may be implemented as illustrated in FIGS. 3 to 5. FIG. 3 illustrates a state before the tailgate is opened, FIG. 4 illustrates a state where the tailgate is partially opened, and FIG. 5 illustrates a state where the tailgate is fully opened.

Meanwhile, a button for opening/closing the tailgate 100 may be disposed on the tailgate 100, a dash panel of the vehicle, or the like. When the button is pressed, an opening or closing signal of the tailgate 100 is generated, and a controller 120 is configured to allow the rotation unit 300 or the sliding unit 500 to operate. Here, two buttons may be disposed. A first button is configured to operate only the rotation unit 300, and a second button is configured to operate the rotation unit 300 and the sliding unit 500 simultaneously.

Alternatively, the vehicle may further include a sensor 110 configured to detect surrounding obstacles. The sensor 110 communicates with the controller 120, and when the controller 120 detects a surrounding obstacle through the sensor 110 and determines that the opening/closing of the tailgate 100 may be hindered by the obstacle, the controller 120 may allow the rotation unit 300 and the sliding unit 500 to operate simultaneously during the opening and closing of the tailgate 100. That is, even when the user presses the first button, the controller 120 may cause the tailgate 100 to open or close while performing the climbing movement.

Referring again to FIG. 2, the rotation unit 300 may include: a first motor 310 disposed on the roof 10 of the vehicle; and a gooseneck bar 330 including a first end portion coupled to a shaft of the first motor 310 and the other end portion coupled to the sliding unit 500. The sliding unit 500 may include: a second motor 510 disposed in the tailgate 100; and a sliding rail 530 disposed in the tailgate to extend in a height direction of the tailgate, the gooseneck bar 330 being slidably coupled to an end portion of the sliding rail 530.

The position where the first motor 310 is disposed is not limited to the roof 10 of the vehicle, and may also be disposed on a side panel 20 around the roof 10 of the vehicle. As illustrated in FIG. 2, the gooseneck bar 330 includes a shape of a bar extending while being bent one or more times, and is coupled at a first end portion thereof to the shaft of the first motor 310. That is, the gooseneck bar 330 rotates by the operation of the first motor 310. The gooseneck bar 330 is coupled at the other end portion thereof to the sliding unit 500. The gooseneck bar 330 is coupled to a sliding rail 530, which will be described later, and the sliding rail 530 is coupled to the tailgate 100. When the first motor 310 operates, a rotation of the tailgate 100 is implemented by the rotation of the gooseneck bar 330.

The second motor 510 is disposed in the tailgate 100. The sliding rail 530 is coupled to the tailgate 100 and extends in a height direction of the tailgate 100. The gooseneck bar 330 is connected at the other end portion thereof to the sliding rail 530, and is slidable along the sliding rail 530. That is, when the second motor 510 operates, the gooseneck bar 330 slides along the sliding rail 530, and a linear movement of the tailgate 100 is added to implement a climbing movement of the tailgate 100 by the first motor 310 and the second motor 510.

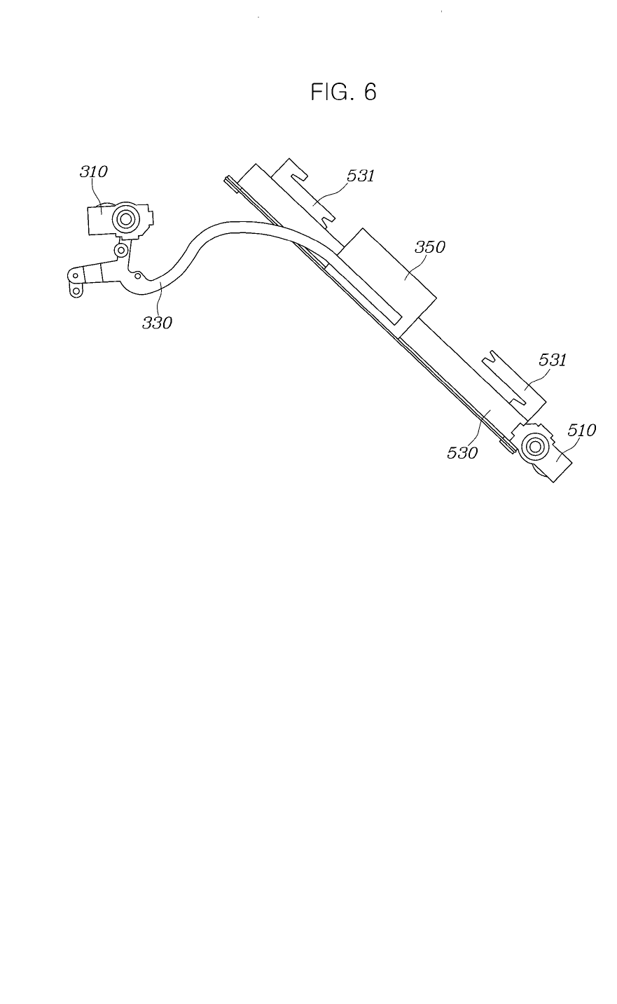

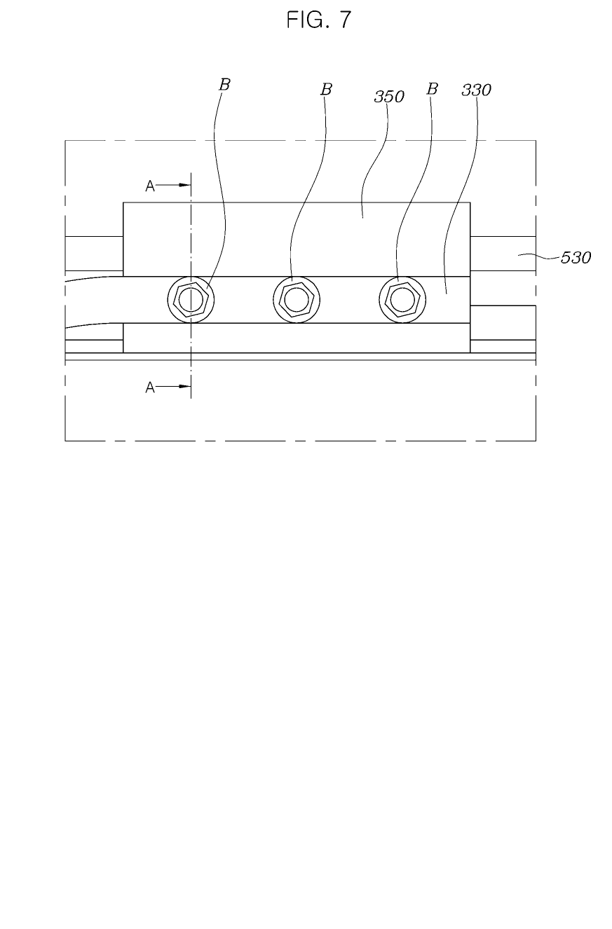

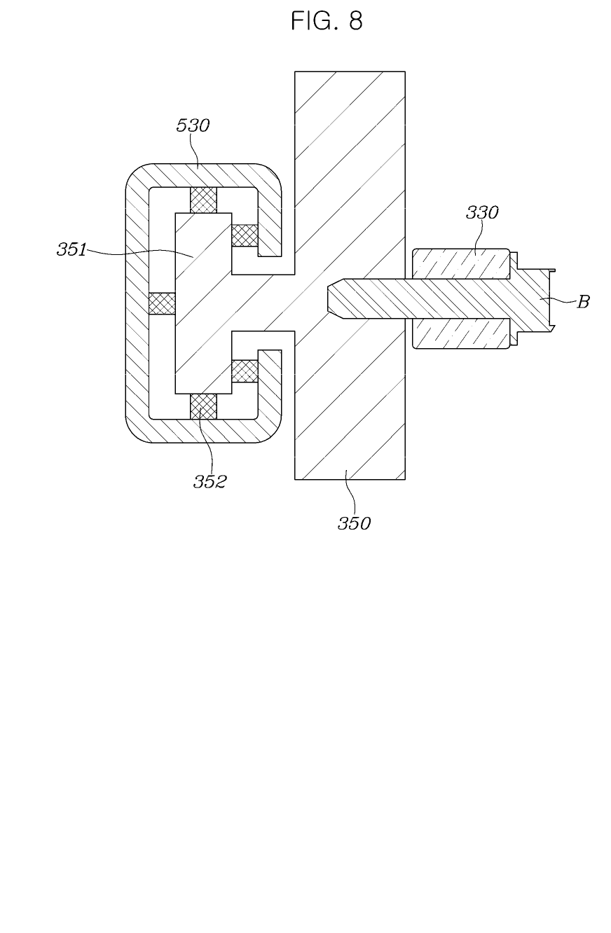

FIG. 6 illustrates the tailgate system excluding a vehicle panel, FIG. 7 illustrates a connection between the gooseneck bar and a roller body, and FIG. 8 illustrates a cross-sectional view taken along line A-A of FIG. 7. Referring to FIGS. 6 to 8, a roller body 350, which is coupled to the sliding rail 530, is disposed at the other end portion of the gooseneck bar 330. The sliding unit 500 may further include a movement unit connected to the second motor 510 to slide the roller body 350. A roller body 350 is connected between the gooseneck bar 330 and the sliding rail 530. The other end portion of the gooseneck bar 330 is positioned on one surface of the roller body 350, and the gooseneck bar 330 and the roller body 350 are fastened together by a bolt B to fix the roller body 350 to the gooseneck bar 330. A rolling portion 351 of the roller body 350 is inserted into the internal side of the sliding rail 530. A plurality of rollers 352 are disposed on an external surface of the rolling portion 351 to allow the roller body 350 to smoothly slide within the sliding rail 530.

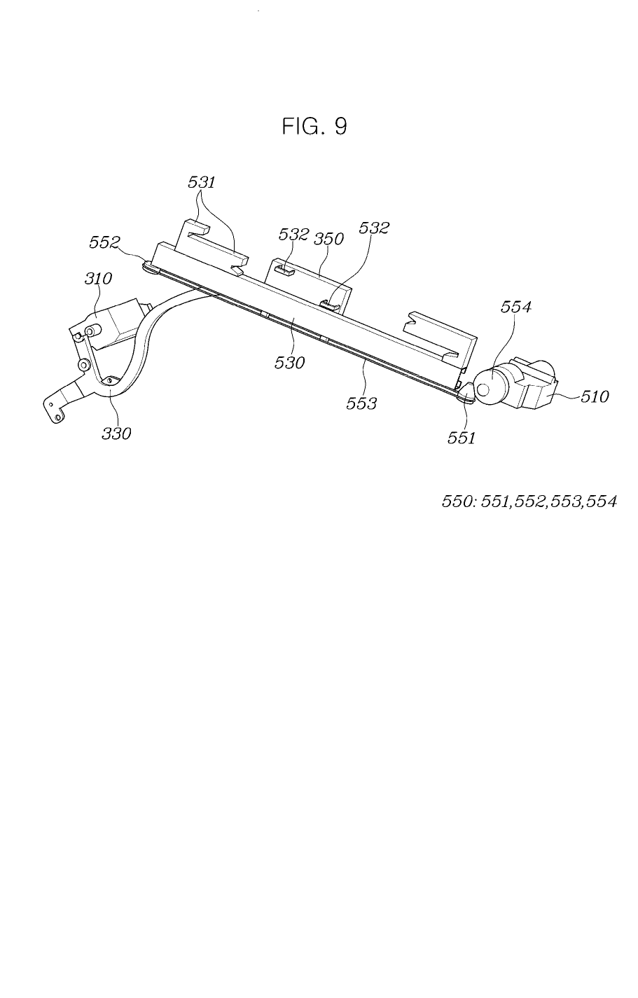

FIG. 9 illustrates a rear view of FIG. 6. Referring to FIG. 9, the movement unit 550 may include: a first pulley 551 disposed at a first end portion of the sliding rail 530 and coupled to the second motor 510; a second pulley 552 disposed at the other end portion of the sliding rail 530; and a cable 553 connected to the first pulley 551 and the second pulley 552 and coupled at both end portions to the roller body 350.

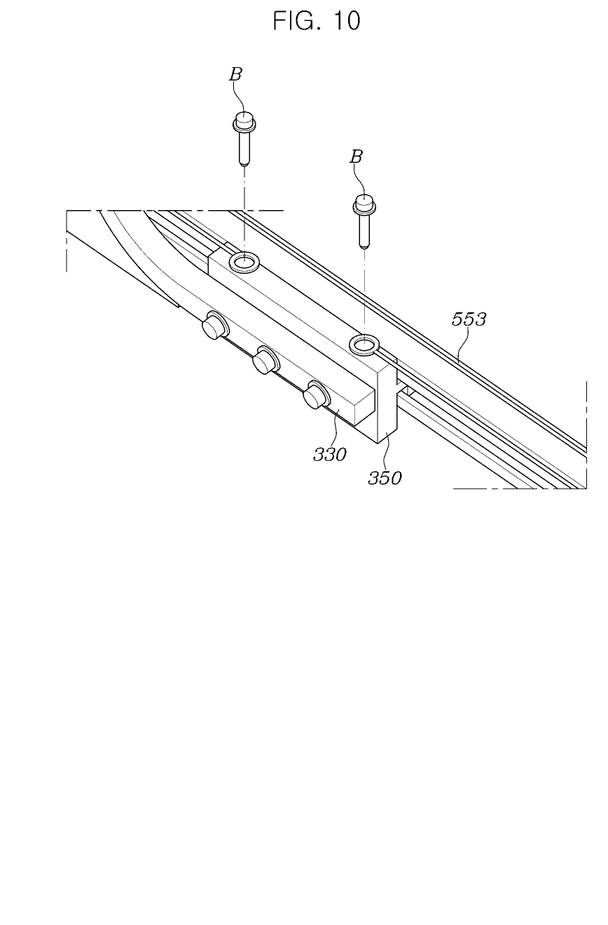

Referring to FIG. 10, the cable 553 may be fixed to the roller body 350 by the bolt B. When the cable 553 is fixed to the roller body 350 by the bolt B, bolt insertion portions into each of which the bolt B is inserted may be disposed at both end portions of the cable 553, and bolt insertion holes may be disposed at two locations of the roller body 350.

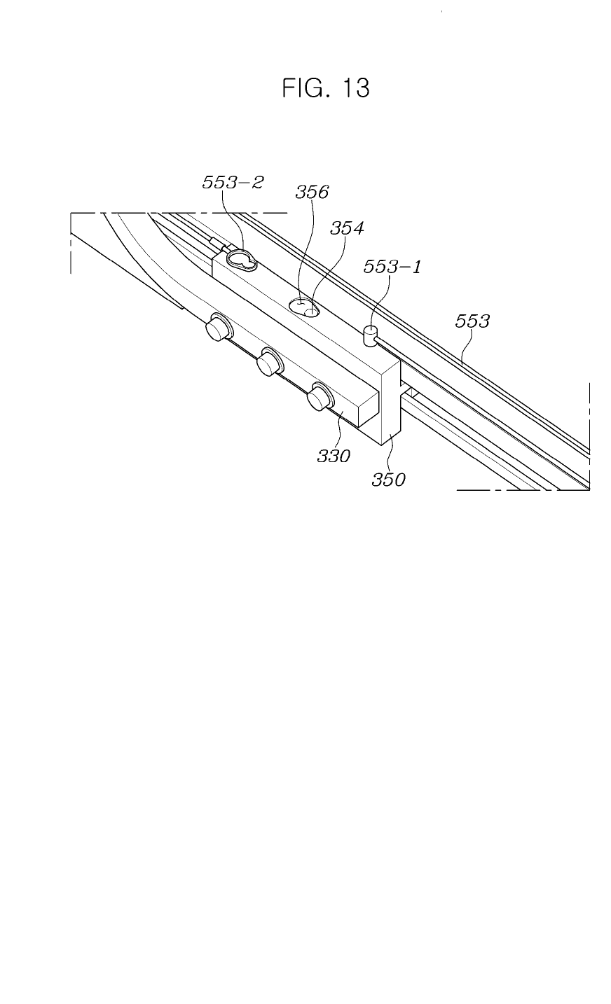

As another embodiment, referring to FIG. 13, a head 553-1 to be inserted into the roller body 350 may be disposed at a first end portion of the cable 553, and a head clip 553-2 to be fastened to the head 553-1 inserted into the roller body 350 may be disposed at the other end portion of the cable 553. The roller body 350 includes a head insertion hole 354 including a shape corresponding to that of the head 553-1 to allow the head 553-1 of the cable 553 to be inserted into the roller body 350, and a clip seating groove 356 may also be disposed in the roller body 350 to allow the head clip 553-2 to be seated in the roller body 350.

Accordingly, the head 553-1 is first inserted into the head insertion hole 354 of the roller body 350, and the head clip 553-2 is connected to the protruding end portion of the head 553-1 and inserted into the clip seating groove 356 disposed in the roller body 350.

By connecting the cable to the roller body in the present manner, slippage of the cable may be prevented during sliding of the roller body.

The cable 553 is connected to the first pulley 551 and the second pulley 552 to span between the first pulley 551 and the second pulley 552. Gear teeth may be disposed on the first pulley 551 and the second pulley 552, and grooves including shapes corresponding to the gear teeth may be disposed on the cable 553 to allow the cable 553 to be coupled the first pulley 551 and the second pulley 552 without being separated therefrom.

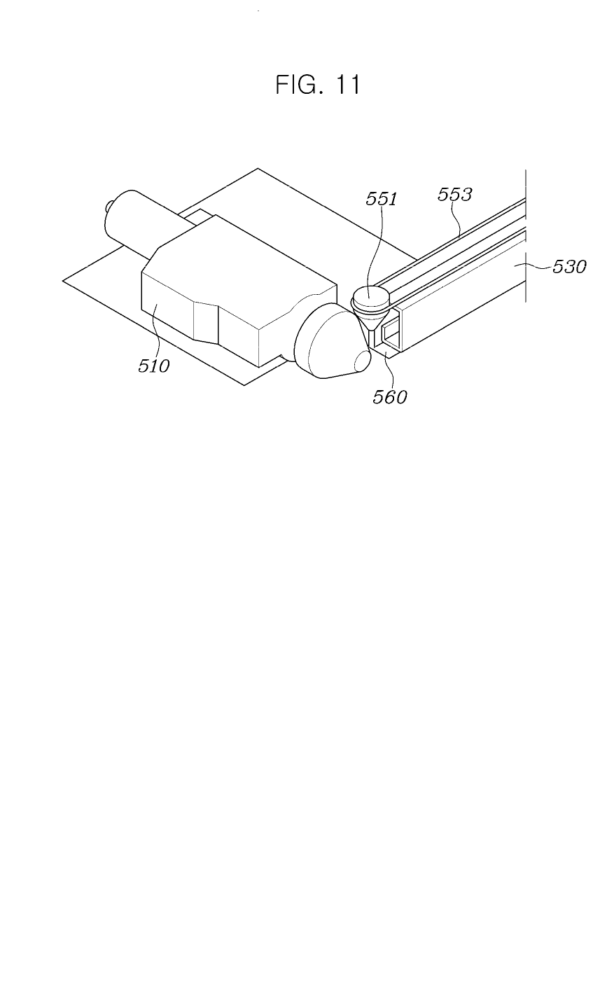

Referring to FIG. 11, a bracket 560 to which the first pulley 551 is coupled may be disposed at a first end portion of the sliding rail 530. The bracket 560 may be coupled by welding to first end portion of the sliding rail 530, and the first pulley 551 is rotatably coupled to the bracket 560. A bevel gear may be disposed at a lower end portion of the first pulley 551 to be mechanically connected to the second motor 510. A bevel gear 554 corresponding to the bevel gear of the first pulley 551 may also be disposed on a shaft of the second motor 510. Accordingly, when the second motor 510 operates, the first pulley 551 may be rotated, the cable 553 may move by the rotation of the first pulley 551 and rotate the second pulley 552, and the roller body 350 may slide along the sliding rail 530 in accordance with the movement of the cable 553.

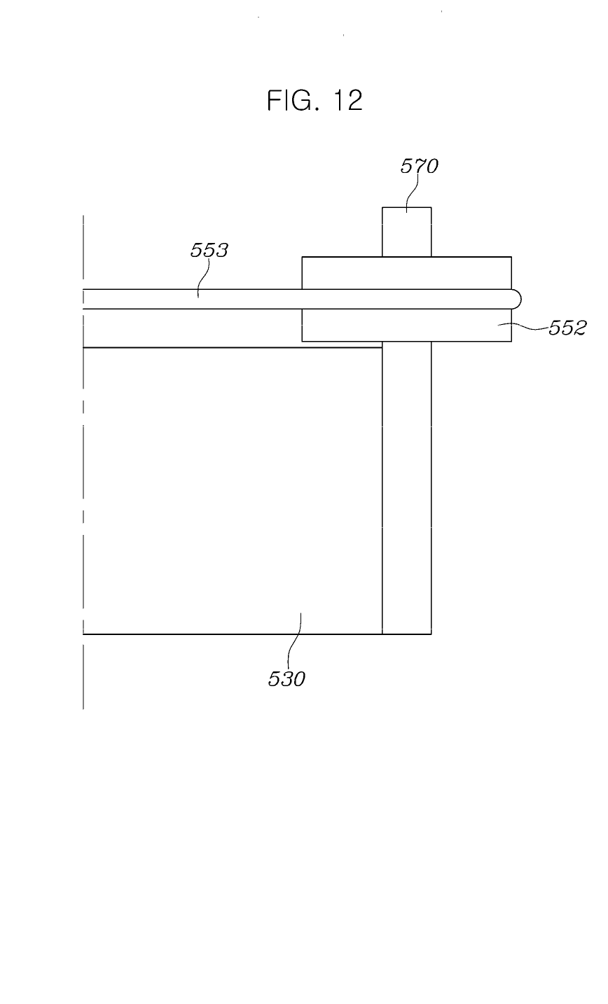

Referring to FIG. 12, a pulley pin 570 is coupled to the other end portion of the sliding rail 530. The pulley pin 570 may be coupled to the other end portion of the sliding rail by welding, and the second pulley 552 may be rotatably coupled to the pulley pin 570.

Referring to FIG. 9, a striker 532 is disposed on one surface of the roller body 350, and a stopper 531 into which the striker 532 is received may be disposed at a first end portion or the other end portion of the sliding rail 530. The striker 532 disposed on the one surface of the roller body 350 may be received in the stopper 531 to restrict the sliding of the roller body 350.

That is, the stopper 531 receives the striker 532 and prevents further sliding of the roller body 350, preventing the roller 352 or the roller body 350 from being separated from the sliding rail. The structure of the stopper 531 may restrict the sliding of the roller body 350 and prevent the roller body 350 from moving abnormally or becoming separated due to external impacts or vibrations, improving the stability and reliability of the tailgate system.

Meanwhile, the stopper 531 may be implemented in various shapes to stably accommodate the striker. For example, the stopper 531 may include a ‘U’-shaped groove, a V-shaped groove, or a circular groove configured for accommodating the striker, and may be made of a specific elastic material to absorb impacts during insertion and removal of the striker 532.

Although the present disclosure has been described and illustrated in conjunction with embodiments thereof, it will be apparent to those skilled in the art that various improvements and modifications may be made to the present disclosure without departing from the technical idea of the present disclosure defined by the appended claims.

What is claimed is:

1. A tailgate system comprising:
a tailgate disposed at a rear of a vehicle to open or close an internal space of the vehicle;
a rotation unit disposed in the vehicle and connected, at an end portion thereof, to the tailgate, the rotation unit being configured to rotate the tailgate by operation; and
a sliding unit disposed in the tailgate and connected, at an end portion thereof, to the rotation unit, the sliding unit being configured to implement a linear movement of the tailgate by selective operation during rotation of the tailgate.

2. The tailgate system of claim 1,
wherein the rotation unit comprises:
a first motor disposed on a roof of the vehicle; and
a gooseneck bar including a first end portion coupled to a shaft of the first motor and a second end portion coupled to the sliding unit, and
wherein the sliding unit includes:
a second motor disposed in the tailgate; and
a sliding rail disposed in the tailgate to extend in a height direction of the tailgate, the second end portion of the gooseneck bar being slidably coupled to an end portion of the sliding rail.

3. The tailgate system of claim 2,
wherein the first motor is configured to rotate the tailgate by rotating the gooseneck bar about the shaft of the first motor, and
wherein, based on that the second motor is selectively operated, a linear movement of the tailgate is implemented and a climbing movement of the tailgate is implemented.

4. The tailgate system of claim 2,
wherein the gooseneck bar includes, at the second end portion thereof, a roller body which is coupled to the sliding rail, and
wherein the sliding unit further includes a movement unit connected to the second motor to slide the roller body.

5. The tailgate system of claim 4, further comprising:
a roller disposed between the roller body and the sliding rail to assist sliding of the roller body.

6. The tailgate system of claim 4, wherein the movement unit comprises:
a first pulley disposed at a first end portion of the sliding rail and connected to the second motor;
a second pulley disposed at a second end portion of the sliding rail; and
a cable coupled to the first pulley and the second pulley, first and second end portions of the cable being coupled to the roller body.

7. The tailgate system of claim 6, wherein the sliding rail comprises, at the first end portion thereof, a bracket to which the first pulley is rotatably coupled.

8. The tailgate system of claim 6, further comprising:
a pulley pin coupled to the second end portion of the sliding rail, wherein the second pulley is rotatably coupled to the pulley pin.

9. The tailgate system of claim 6,
wherein the second motor comprises a bevel gear disposed on a shaft of the second motor and engaged to the first pulley, and
wherein operation of the bevel gear causes the first pulley and the second pulley to rotate through the cable to slide the roller body.

10. The tailgate system of claim 6,
wherein the roller body includes a striker on one surface thereof,
wherein the sliding rail includes, at the first end portion or the second end portion thereof, a stopper configured to receive the striker, and
wherein the stopper is configured to restrict sliding of the roller body.

11. The tailgate system of claim 6, wherein the cable is fixed to the roller body by a bolt.

12. The tailgate system of claim 6, wherein the cable comprises, at the first end portion thereof, a head configured to be inserted into the roller body, and at the second end portion thereof, a head clip configured to be fastened to the head inserted into the roller body.

13. The tailgate system of claim 12, wherein the roller body comprises, at a predetermined portion thereon, a head insertion hole into which the head is inserted, and around the head insertion hole, a clip seating groove into which the head clip is seated.

14. The tailgate system of claim 1, further comprising:
a first button configured to operate only the rotation unit, based on activation of the first button; and
a second button configured to operate the rotation unit and the sliding unit simultaneously, based on activation of the second button.

15. The tailgate system of claim 14, further comprising:
a sensor configured to detect a surrounding obstacle,
a controller operatively connected to the sensor, the rotation unit and the sliding unit and, based on concluding that opening or closing of the tailgate is to be hindered by the surrounding obstacle, the controller controls the rotation unit and the sliding unit to operate simultaneously during the opening and closing of the tailgate, even if the first button is activated.

16. The tailgate system of claim 2, further comprising:
a sensor configured to detect a surrounding obstacle,
a controller operatively connected to the sensor, the first motor of the rotation unit and the second motor of the sliding unit and, based on concluding that opening or closing of the tailgate is to be hindered by the surrounding obstacle, the controller controls the first motor of the rotation unit and the second motor of the sliding unit to operate simultaneously during the opening and closing of the tailgate.

17. A vehicle comprising the tailgate system of claim 1.
